(19) United States
(12) Patent Application Publication
(10) Pub. No.: US 2023/0064342 A1
(43) Pub. Date: Mar. 2, 2023

(54) SOLE WITH INTEGRATED MASSAGE APPARATUS

(71) Applicant: Leslie Chan Dotson, Carson, CA (US)

(72) Inventor: Leslie Chan Dotson, Carson, CA (US)

(21) Appl. No.: 18/049,057

(22) Filed: Oct. 24, 2022

Related U.S. Application Data
(60) Provisional application No. 63/236,291, filed on Aug. 24, 2021.

(51) Int. Cl. A61H 39/04; A61H 39/00; A61H 9/00

(52) U.S. Cl. CPC A61H 39/04; A61H 39/002; A61H 9/0078; A61H 39/007; A61H 2201/5005; A61H 2201/5097; A61H 2201/165; A61H 2205/125; A61H 2201/164; A61H 2039/005

(57) ABSTRACT

A massage apparatus and system are herein disclosed. The massage apparatus is embedded in a sole or insole of a shoe and includes a controller, massage pads, and a battery. The controller communicates with a remote controller to selectively activate the massage pads. The present invention allows for customizable massaging at reflexology regions of a user's foot.

### CROSS-REFERENCE TO RELATED APPLICATION

This application claims the benefit of priority of U.S. provisional application No. 63/236,291, filed Aug. 24, 2021, the contents of which are herein incorporated by reference.

### BACKGROUND OF THE INVENTION

The present invention relates to shoe soles and, more particularly, to massage functions implemented via a shoe sole or a shoe exterior.

In today's society, shoes play a big part of the health of a human body and, in some cases, cause health issues to the body if not properly worn correctly. The shoes that are on the market today are limited in healing properties/processes and, at best, are stopping the healing process of the body from its natural healing function with body organs. The soles and or shoes on the market today only form or adjust the feet for bone structure and posture. They do not interact with the body organs and, in some cases, if an individual does not wear the proper shoes than it can cause body injury.

Conventional soles are mostly generic, and they do not provide electronic pulses and or stimulations to the feet, which cuts off blood flow and proper function of the feet intended to naturally occur. In some cases, the shoes can hurt the feet and give pain, hence why foot doctors and Chinese foot massage people exist to attempt to temporarily heal peoples' feet until they put back on shoes that cause the issue in the first place. While certain massage insoles exist, the position and amount of stimulation a massage bead provides to the foot is fixed, and often results in the foot feeling sore after extended use.

As can be seen, there is a need for an improved shoe sole or shoe exterior that delivers effective and adjustable massaging to a user's foot.

### SUMMARY OF THE INVENTION

In one aspect of the present invention, a massage apparatus embedded in a sole or insole of a shoe includes: a controller embedded in the sole or insole; a plurality of massage pads embedded in and distributed across the sole or insole and operatively associated with the controller, each massage pad being selectively activatable by the controller to initiate a massage signal; and a battery for powering the controller and the plurality of massage pads.

In another aspect of the present invention, a massage system includes: a remote controller; a massage apparatus embedded in a sole or insole of a shoe, the massage apparatus comprising: a controller embedded in the sole or insole and configured to communicate with the remote controller; a plurality of massage pads embedded in and distributed across the sole or insole and operatively associated with the controller, each massage pad being selectively activatable by the controller to initiate a massage signal; and a battery for powering the controller and the plurality of massage pads.

These and other features, aspects and advantages of the present invention will become better understood with reference to the following drawings, description, and claims.

### BRIEF DESCRIPTION OF THE DRAWINGS

The following figures are included to illustrate certain aspects of the present disclosure and should not be viewed as exclusive embodiments. The subject matter disclosed is capable of considerable modifications, alterations, combinations, and equivalents in form and function, without departing from the scope of this disclosure.

FIG. 1 is a side elevation of an embodiment of the present invention, shown in use;

FIG. 2 is a schematic side elevation view of the embodiment of the present invention;

FIG. 3 is a schematic top plan view taken along line 3-3 of FIG. 2;

FIG. 4 is a schematic plan view, showing sample reflexology regions of a foot; and

FIG. 5 is a top plan view of a mobile device displaying a control application of the embodiment of the present invention.

### DETAILED DESCRIPTION OF THE INVENTION

The following detailed description is of the best currently contemplated modes of carrying out exemplary embodiments of the present invention. The description is not to be taken in a limiting sense but is made merely for the purpose of illustrating the general principles of the present invention, since the scope of the present invention is best defined by the appended claims.

Broadly, an embodiment of the present invention provides a sole with an integrated massage apparatus. The present invention allows the soles in the shoes and or exterior soles placed into the shoes to have built in electronic pulses, pressure points, massaging motion or light sensors to the precise points in the feet of human beings that are connected biologically to other human organs. In preferred embodiments of the present invention, the soles can interact with the feet electronically giving the feet the necessary signals and pressure points to not allow them to be tired, inflamed, ache or stop proper blood flow. The signals to the feet, which signal from the soles of the shoe or external soles placed into shoes, are advantageously placed in area points where the body organs connect through the nervous system, with the vibrational impulses, pressure points and/or massaging motions allowing improved function of the body organs from those signals. The overall effect on the human foot and body is like a Chinese foot massage and or a visit to the foot doctor—the difference is the individual is getting the treatment while wearing shoes.

All items, unless otherwise noted, are important in order to make the function of the product to work properly. In certain embodiments, a USB port for charging outside the shoe may be eliminated. People can use wireless power transfer, such as inductive charging via a Qi charger, with the need of the USB charging connector or vice versa. For example, wireless charging could be eliminated to provide a more cost-effective solution.

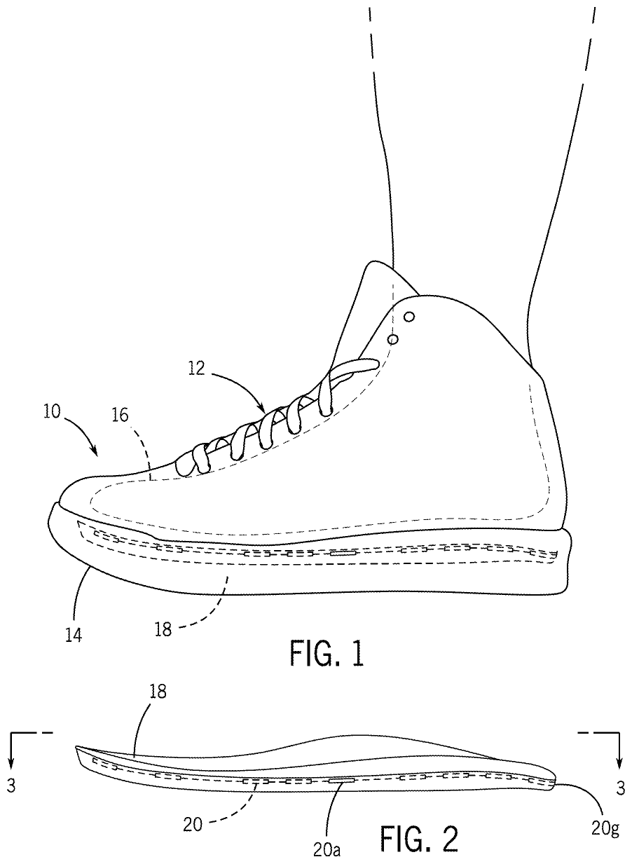

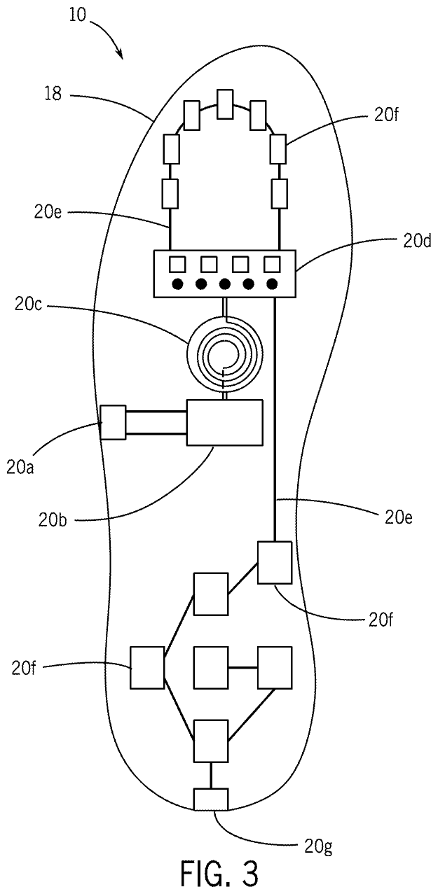

Referring now to FIGS. 1-5, a reflexology massage treatment system 10 is disclosed. The system 10 functions by utilizing electronic pulses (or one of the previously mentioned methods) in an insole 18 or sole 14 of a shoe 12 to massage a foot 16 of a user. A person with skill in the art would appreciate that the teachings of the present invention may be applied to removable insoles 18 (see FIG. 2), to allow any shoe 12 to function in accordance with the present invention, or to the soles 14 themselves, to provide a shoe 12 that operates in accordance with the present invention.

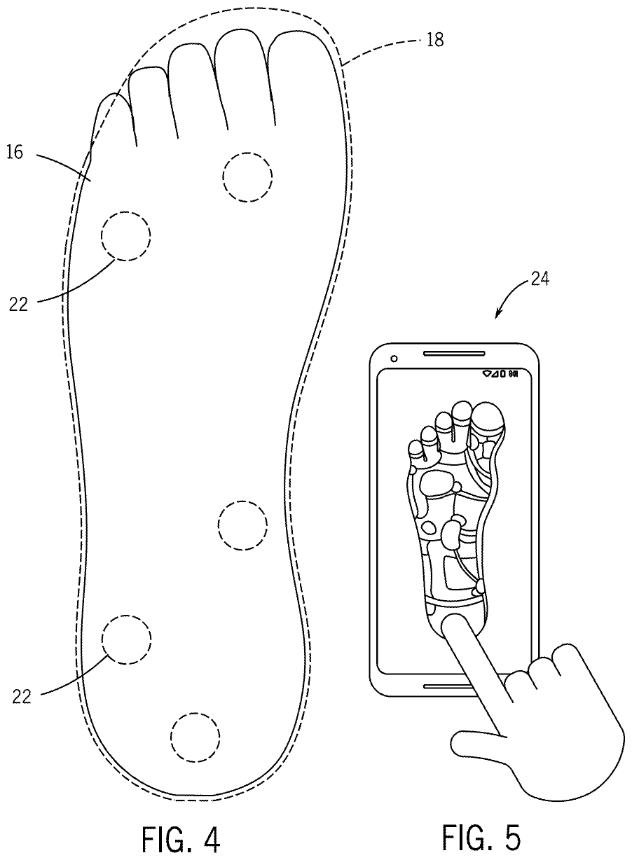

Reference number 20 generally denotes a massage apparatus 20 that massages the foot 16 of the user. In certain embodiments, the apparatus 20 may include a USB port 20a for charging a rechargeable battery 20b. In others or the same embodiment, a wireless battery charger 20c (such as a Qi battery charger) may be provided to charge the battery 20b. A controller 20d, embodied as a printed circuit board with controller, is embedded in the insole 18, powered by the battery 20b, and controls operation of the rest of the massage apparatus 20. Specifically, trace wires 20e connect the controller 20d to massage/contact pads 20f disposed such that they target various regions of the foot 16, in use. The massage pads 20f are embedded in the insole 18, as shown in FIG. 3. As shown in FIG. 4, typical reflexology regions 22 are the areas that are best served to be treated with the pads 20f of the present invention. A transceiver 20g is further provided to communicate with a control application 24, which may be embodied as an application on a mobile device, for example, as shown in FIG. 5. In use, the control application 24 may be used to selectively activate certain pads 20f or all of them. In certain embodiments, the pads 20f may have customized electronic intensities and/or patterns of vibrations, for example. Other forms of control, such as a remote controller, may be utilized in accordance with the present invention.

It will be appreciated that different methods of signal transfer to the feet from the soles may be used, such as pulse signals (e.g., electronic pulsations), massage vibration motors, light signals, pressure pads, or by air inflations. Further, as mentioned, it is also possible to fix the soles into shoes such that they are not removable, and the shoe may be built around the sole in production. Removeable soles may be embodied such that they go in and out of any shoe, just by cutting the tip of the sole to form different sizes. For example, there may be cut lines in sole at size 8, 9, 10, 11, and 12. In other embodiments, solar power may be added to shoe exterior to run the battery. The concepts of the sole described herein may also be applied to clothing, like jackets, shirts, hats, and other apparel items. The items described herein can also be used in car seats or airplane seats or floors for passengers so while they are on long drives or flights. This can also be used in a home or commercial spas, where the customer can use embodiments of the present invention as floor mats while watching TV or at the spa. Embodiments of the present invention can be used in massage chairs in the foot area and may also be used in furniture that interacts with the human feet and/or other body parts. Consequently, various products may be produced by the present invention, such as a removable sole, a shoe with an integrated sole, foot mats to be used anywhere, socks with massaging soles, and various clothing and furniture with aspects of the present invention incorporated therein.

To make embodiments of the present invention, soles can be manufactured out of any manmade or natural materials and are embedded with electronic trace wires, connectors that send signals to the pad/contact points to the specific feet area that are connected to the feet mapping of organ functions, recharge batteries provide power to a printed circuit board assembly (PCBA), provides logic to wireless modules, central processing unit/application specific integrated circuit (CPU/ASIC) and any other electronic device combination to send the signals properly to the feet and which is transmitted to other body organs via the reflexology regions. The shoe sole electronics can be monitored and/or controlled wirelessly by a phone, tablet, or other remote-control device, and ran through a programmed information technology (IT) application with a wireless signal, such as BLUETOOTH™ and or WIFI™ signal, ran off a rechargeable battery also integrated in the shoe. This battery can be charged wirelessly through a QI charger and/or conductive charging method or ran off rechargeable batteries or human heat conduction power charging.

A method of using the present invention may include the following. The present invention allows the soles in the shoes and/or exterior soles placed into the shoes by the customer that have built-in electronic pulses, pressure points, massaging motion, or light sensors to the exact points in the feet of human beings that are connected scientifically to the human organs. As described above, the soles can interact with the feet electronically giving the feet the necessary signals and pressure points to not allow them to be tired, inflamed, ache or stop proper blood flow. The signals to the feet originate from the soles of the shoe or external soles placed into shoes and are targeted in the area points where the body organs connect through the nervous system and then can the body organs can function properly from those signals through vibrational impulses, pressure points and or massaging motion. To operate, a user simply needs to activate the pads in the sole via the application or other remote controller. When the sole is in need of a charge, the various forms of charging described herein may be utilized.

The present invention has been described in terms of exemplary embodiments solely for the purpose of illustration. Persons skilled in the art will recognize from this description that the invention is not limited to the embodiments described but may be practiced with modifications and alterations limited only by the spirit and scope of the appended claims.

What is claimed is:

1. A massage apparatus embedded in a sole or insole of a shoe, the massage apparatus comprising:
a controller embedded in the sole or insole;
a plurality of massage pads embedded in and distributed across the sole or insole and operatively associated with the controller, each massage pad being selectively activatable by the controller to initiate a massage signal; and
a battery for powering the controller and the plurality of massage pads.

2. The massage apparatus of claim 1, wherein the massage signal is an electronic pulsation, a vibration of the massage pad, a light signal, pressure via a pressure pad, or inflation of the massage pad.

3. The massage apparatus of claim 1, further comprising a transceiver for communicating with a remote controller.

4. The massage apparatus of claim 1, further comprising a port or a wireless battery charger for charging the battery.

5. The massage apparatus of claim 1, wherein the plurality of massage pads are positioned to correspond to reflexology regions of a foot.

6. A massage system comprising:
a remote controller;
a massage apparatus embedded in a sole or insole of a shoe, the massage apparatus comprising:
a controller embedded in the sole or insole and configured to communicate with the remote controller;
a plurality of massage pads embedded in and distributed across the sole or insole and operatively associated with the controller, each massage pad being selectively activatable by the controller to initiate a massage signal; and
a battery for powering the controller and the plurality of massage pads.

7. The massage system of claim 6, wherein the remote controller is a control application installed on a mobile device.

8. The massage system of claim 6, wherein the massage signal is an electronic pulsation, a vibration of the massage pad, a light signal, pressure via a pressure pad, or inflation of the massage pad.

9. The massage system of claim 6, further comprising a transceiver for communicating with the remote controller.

10. The massage system of claim 6, wherein the plurality of massage pads are positioned to correspond to reflexology regions of a foot.
